(19) United States
(12) Patent Application Publication
(10) Pub. No.: US 2017/0063657 A1
(43) Pub. Date: Mar. 2, 2017

(54) CONNECTION STATUS PROMPTING METHOD AND DEVICE

(71) Applicant: Xiaomi Inc., Beijing (CN)

(72) Inventors: Shuo WANG, Beijing (CN); Bin WANG, Beijing (CN); Bo WANG, Beijing (CN)

(73) Assignee: Xiaomi Inc.

(21) Appl. No.: 15/139,463

(22) Filed: Apr. 27, 2016

(30) Foreign Application Priority Data
Aug. 31, 2015 (CN) 201510546602.1

(51) Int. Cl. H04L 12/26; H04W 8/00; H04W 24/08

(52) U.S. Cl. CPC H04L 43/0811; H04W 24/08; H04W 8/005; H04W 84/12

(57) ABSTRACT

A connection status prompting method includes periodically accessing a specified domain name through a Wireless-Fidelity (WiFi) network and making a request for acquiring a network resource to a network server corresponding to the specified domain name. The network server is in a public network. The method further includes determining a connection status between the WiFi network and the public network according to an acquisition result of the network resource. The connection status includes one of a connected status or a disconnected status. The method also includes presenting the connection status to a user.

### CROSS-REFERENCE TO RELATED APPLICATIONS

This application claims priority to Chinese Patent Application No. 201510546602.1, filed on Aug. 31, 2015, the entire contents of which are incorporated herein by reference.

### TECHNICAL FIELD

The present disclosure generally relates to networks and, more particularly, to a connection status prompting method and device.

### BACKGROUND

Wireless-Fidelity (WiFi) is a wireless connection technology. Wireless networks employing the WiFi technology are widely used nowadays, and the WiFi technology becomes more and more important in people's daily life.

In conventional technologies, to prompt a connection status, a terminal establishes a WiFi connection with a wireless router connected with a public network, acquires a WiFi signal strength of a WiFi network provided by the wireless router, and displays the WiFi signal strength to a user as the connection status.

### SUMMARY

In accordance with the present disclosure, there is provided a connection status prompting method including periodically accessing a specified domain name through a Wireless-Fidelity (WiFi) network and making a request for acquiring a network resource to a network server corresponding to the specified domain name. The network server is in a public network. The method further includes determining a connection status between the WiFi network and the public network according to an acquisition result of the network resource. The connection status includes one of a connected status or a disconnected status. The method also includes presenting the connection status to a user.

Also in accordance with the present disclosure, there is provided a connection status prompting device including a processor and a memory storing instructions that, when executed by the processor, cause the processor to periodically access a specified domain name through a Wireless-Fidelity (WiFi) network and make a request for acquiring a network resource to a network server corresponding to the specified domain name. The network server is in a public network. The instructions further cause the processor to determine a connection status between the WiFi network and the public network according to an acquisition result of the network resource. The connection status includes one of a connected status or a disconnected status. The instructions also cause the processor to present the connection status to a user.

Also in accordance with the present disclosure, there is provided a non-transitory computer-readable storage medium having stored therein instructions that, when executed by a processor of a mobile terminal, cause the mobile terminal to periodically access a specified domain name through a Wireless-Fidelity (WiFi) network and make a request for acquiring a network resource to a network server corresponding to the specified domain name. The network server is in a public network. The instructions further cause the mobile terminal to determine a connection status between the WiFi network and the public network according to an acquisition result of the network resource. The connection status includes one of a connected status or a disconnected status. The instructions also cause the mobile terminal to present the connection status to a user.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a schematic diagram illustrating an implementation environment related to a connection status prompting method according to an exemplary embodiment.

FIG. 2 is a flow chart showing a connection status prompting method according to an exemplary embodiment.

FIG. 3A is a flow chart showing a connection status prompting method according to another exemplary embodiment.

FIG. 3B is a flow chart showing an exemplary process for determining a connection status.

FIG. 3C is a flow chart showing another exemplary process for determining a connection status.

FIG. 3D is a schematic diagram illustrating connection status prompting in a conventional technology.

FIGS. 3E and 3F are schematic diagrams illustrating display of a connection status to a user according to exemplary embodiments.

FIG. 4 is a schematic diagram illustrating display of a connection status to a user according to another exemplary embodiment.

FIG. 5 is a flow chart showing a connection status prompting method according to another exemplary embodiment.

FIG. 6 is a flow chart showing a connection status prompting method according to another exemplary embodiment.

FIG. 7 is a flow chart showing a connection status prompting method according to another exemplary embodiment.

FIG. 8 is a block diagram illustrating a connection status prompting device according to an exemplary embodiment.

FIG. 9 is a block diagram illustrating a connection status prompting device according to another exemplary embodiment.

FIG. 10 is a block diagram illustrating a connection status prompting device according to another exemplary embodiment.

FIG. 11 is a block diagram illustrating a connection status prompting device according to another exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

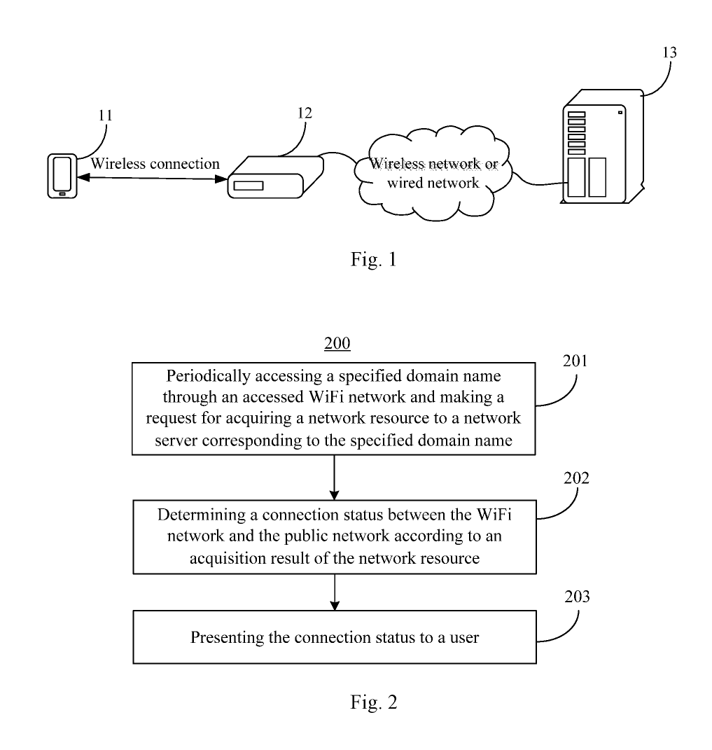

FIG. 1 is a schematic diagram illustrating an implementation environment related to a connection status prompting method consistent with the present disclosure. As shown in FIG. 1, the implementation environment includes a terminal 11, a WiFi access point (AP) 12, and a network server 13. The terminal 11 can be, for example, a mobile phone, a tablet Personal Computer (PC), a laptop computer, a desktop computer, or the like. The WiFi AP 12 can be a device with a network access function, such as a router. The WiFi AP 12 can establish a wireless connection, such as a WiFi connection or a BlueTooth connection, with the terminal 11. The WiFi AP 12 can further establish a connection with a public network. The public network can be, for example, the Internet. The network server 13 can be a server, a server cluster including a plurality of servers, or a cloud computing service center. The network server 13 has a public network address, and the WiFi AP 12 can access the network server 13 through the connection established with the public network.

In FIG. 1, one terminal 11 and one WiFi AP 12 are shown for illustrative purposes. However, the implementation environment can include more than one terminal and/or more than one WiFi AP.

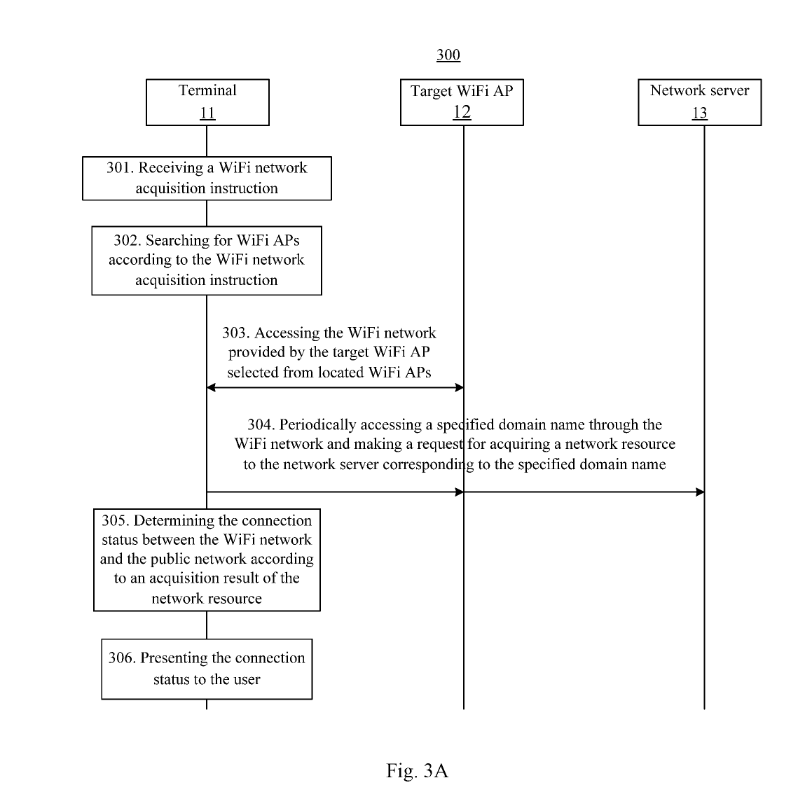

FIG. 2 is a flow chart showing a connection status prompting method 200 according to an exemplary embodiment. The method 200 can be implemented, for example, in the terminal 11 in the implementation environment shown in FIG. 1. As shown in FIG. 2, at 201, a specified domain name is periodically accessed through an accessed WiFi network, and a request for acquiring a network resource is made to a network server corresponding to the specified domain name. At 202, a connection status between the WiFi network and the public network is determined according to an acquisition result of the network resource. The connection status includes a connected status and a disconnected status. At 203, the connection status is presented to a user.

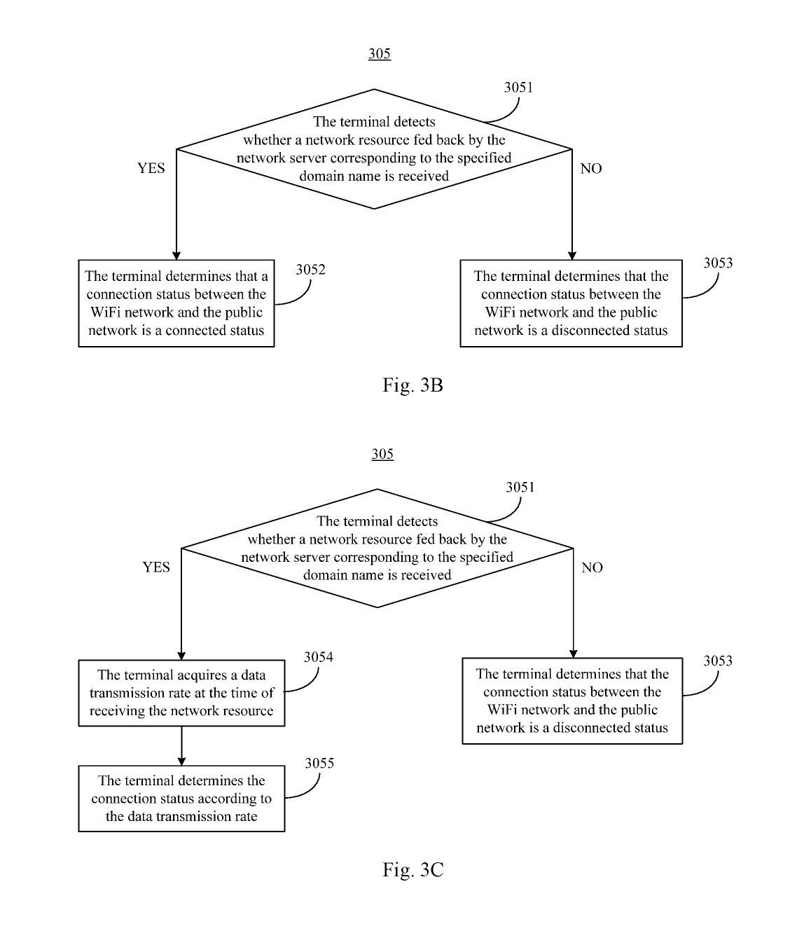

FIG. 3A is a flow chart showing a connection status prompting method 300 according to another exemplary embodiment. The method 300 can be implemented, for example, in the implementation environment shown in FIG. 1. As shown in FIG. 3A, at 301, the terminal 11 receives a WiFi network acquisition instruction. That is, when the terminal 11 is not connected to a WiFi network provided by the WiFi AP 12, the terminal 11 receives the WiFi network acquisition instruction. The WiFi network acquisition instruction can be, for example, sent by a user when the user needs to connect the terminal 11 to the WiFi network. Alternatively, the terminal 11 can also automatically acquire the WiFi network acquisition instruction when the terminal 11 is turned on.

At 302, the terminal 11 searches for WiFi APs according to the WiFi network acquisition instruction. A WiFi AP can continuously broadcast its own device information. For example, device information of a wireless router can include a Service Set Identifier (SSID) and a Media Access Control (MAC) address. The terminal 11 can search for the device information broadcast by a nearby WiFi APs.

At 303, the terminal 11 accesses the WiFi network provided by a target WiFi AP. The target WiFi AP can be selected from WiFi APs located by the search, such as the WiFi AP 12 shown in FIG. 1. As such, a WiFi connection is established between the terminal 11 and the WiFi AP 12.

In some embodiments, to select the target WiFi AP from the located WiFi APs, the terminal 11 removes encrypted WiFi APs whose passwords are not stored in the terminal 11, removes WiFi APs whose signal strength is lower than a signal threshold value, and determines one of the remaining WiFi APs as the target WiFi AP.

At 304, the terminal 11 periodically accesses a specified domain name through the WiFi network, and makes a request for acquiring a network resource to the network server 13 corresponding to the specified domain name. The specified domain name can be a public network domain name, so that the network server 13 can receive the request when a connection between the target WiFi AP 12 and the public network is established. The periodic access by the terminal 11 to the specified domain name can ensure that the connection status is timely acquired. The access period can be preset, for example, to be 10 minutes.

At 305, the terminal 11 determines the connection status between the WiFi network and the public network according to an acquisition result of the network resource. FIGS. 3B and 3C show two exemplary processes, respectively, for determining the connection status.

As shown FIG. 3B, at 3051, the terminal 11 detects whether the network resource fed back by the network server 13 corresponding to the specified domain name is received. If the terminal 11 receives the network resource fed back by the network server 13 (3051: YES), the terminal 11 determines that the connection status between the WiFi network and the public network is a connected status (3052 in FIG. 3B). This means that the connection between the target WiFi AP 12 and the public network is established, and the terminal 11 can normally access the public network through the WiFi network provided by the target WiFi AP 12. On the other hand, if the terminal 11 does not receive the network resource fed back by the network server 13 (3051: NO), the terminal 11 determines that the connection status between the WiFi network and the public network is a disconnected status (3053 in FIG. 3B). This means that the connection between the target WiFi AP 12 and the public network is not established, and the terminal cannot normally access the public network through the WiFi network provided by the target WiFi AP 12.

In some embodiments, the terminal 11 sets a receiving time limit, which can be a period of time from the time that the terminal 11 starts to access the specified domain name. If the terminal 11 does not receive the network resource fed back by the network server 13 within the receiving time limit, the terminal 11 can determine that the network resource is not received.

Alternatively, as shown in FIG. 3C, if the terminal 11 receives the network resource fed back by the network server 13 (3051: YES), the terminal acquires a data transmission rate at the time of receiving the network resource (3054 in FIG. 3C). Then, at 3055, the terminal determines the connection status according to the data transmission rate. The connection status here can be configured to indicate the connected status.

In some embodiments, the terminal 11 can stop accessing the WiFi network provided by the target WiFi AP 12 after determining the connection status.

Referring again to FIG. 3A, at 306, the terminal 11 presents the connection status to the user. The terminal 11 may present the connection status to the user by, for example, displaying the connection status in a graphical user interface of the terminal 11, playing the connection status via an audio component of the terminal 11, or displaying the connection status on the graphical user interface and playing the connection status via the audio component.

Usually, the WiFi AP 12 is connected to a public network access node. The public network access node, however, may be disconnected from the public network because of various reasons, such as line damage. In conventional technologies, as shown in FIG. 3D, a terminal only displays SSIDs 31 broadcast by WiFi APs and corresponding signal strengths 32 on a graphical user interface. The user does not know which WiFi AP has access to the public network. On the other hand, according to the connection status prompting methods of the present disclosure, connection statuses of the located WiFi APs to a public network are also acquired and presented to the user. For example, as shown in FIG. 3E, the terminal 11 displays SSIDs 31 of the WiFi APs and corresponding signal strengths 32 and connection statuses 33 to the user. A symbol “!” in FIG. 3E indicates the corresponding WiFi AP is in the disconnected status, and a blank without the symbol “!” indicates the corresponding WiFi AP is in the connected status. Other symbols or indications can also be used to indicate the connection status. For example, symbol “X ” can represent a disconnected status and symbol “√” can represent a connected status.

In some embodiments, other presentation manners can also be adopted for indicating the connection status. For example, as shown in FIG. 3F, data transmission rates 33a acquired at the time of receiving the network resource can also be displayed as connection statuses indicating the connected status to a public network.

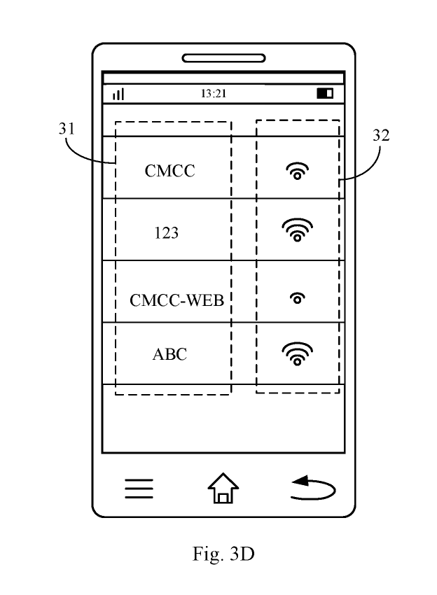

As shown in FIG. 4, the terminal 11 can display a WiFi signal strength indicator 41 and a connection status 42 next to the WiFi signal strength indicator 41. The WiFi signal strength indicator 41 indicates the signal strength of the WiFi AP 12 that the terminal 11 currently connected to, and the connection status 42 indicates the connection status of the WiFi AP 12 to a public network. As such, the user can directly learn about related information of the currently connected WiFi network.

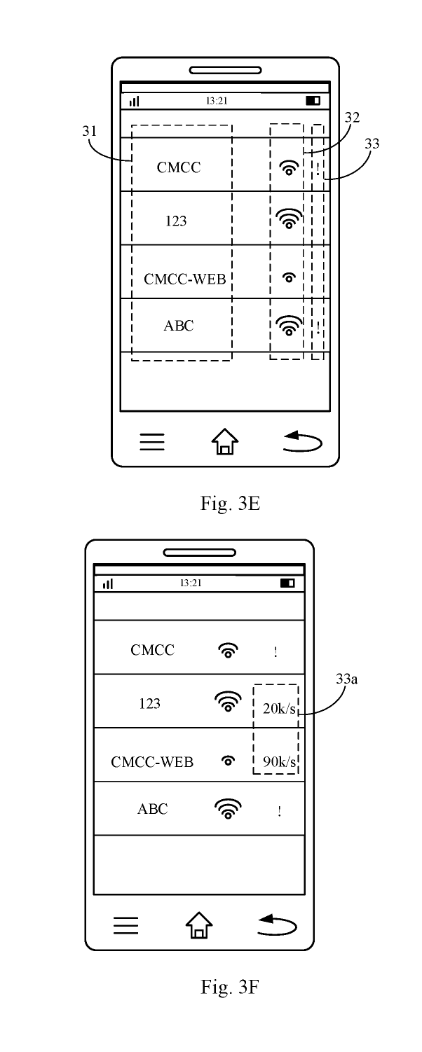

FIG. 5 is a flow chart showing a connection status prompting method 500 according to another exemplary embodiment. The method 500 can be implemented, for example, in the WiFi AP 12 in the implementation environment shown in FIG. 1. As shown in FIG. 5, at 501, a specified domain name is periodically accessed, and a request for acquiring a network resource is made to the network server 13 corresponding to the specified domain name. At 502, a connection status between a WiFi network and the public network is determined according to an acquisition result of the network resource. The connection status includes a connected status and a disconnected status. At 503, the connection status is provided to the terminal 11 for the terminal to present to a user.

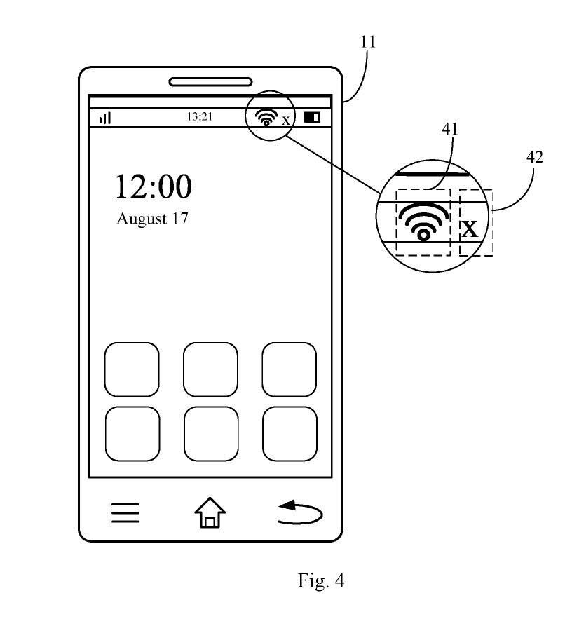

FIG. 6 is a flow chart showing a connection status prompting method 600 according to another exemplary embodiment. The method 600 can be implemented, for example, in the implementation environment shown in FIG. 1. As shown in FIG. 6, at 601, the WiFi AP 12 periodically accesses a specified domain name, and makes a request for acquiring a network resource to the network server 13 corresponding to the specified domain name. In some embodiments, the WiFi AP 12 can access the specified domain name through a connection with a public network access node, which refers to a port configured to provide a connection with the public network. The public network access node may be disconnected from the public network because of various reasons, such as line damage.

At 602, the WiFi AP 12 determines a connection status between a WiFi network and the public network according to an acquisition result of the network resource. The connection status includes a connected status and a disconnected status. The WiFi network is provided by the WiFi AP 12, and thus the connection status between the WiFi network and the public network is a connection status between the WiFi AP 12 and the public network. For example, if the WiFi AP 12 receives the network resource provided by the network server 13, the WiFi AP 12 can determine that the connection status between the WiFi network and the public network is the connected status. On the other hand, if the WiFi AP 12 does not receive the network resource provided by the network server 13, the WiFi AP 12 can determine that the connection status between the WiFi network and the public network is the disconnected status.

In some embodiments, the WiFi AP 12 can measure a data transmission rate at the time of acquiring the network resource when the network resource provided by the network server is acquired, and include the data transmission rate in the connection status.

At 603, the WiFi AP 12 broadcasts the connection status. In some embodiments, the WiFi AP 12 can include the connection status in device information and broadcast the device information. The device information can further include an SSID and a MAC address of the WiFi AP 12.

At 604, the terminal 11 acquires the connection status broadcast by the WiFi AP 12. In some embodiments, the terminal 11 discovers WiFi APs according to a WiFi network acquisition instruction and selects the WiFi AP 12 from the discovered WiFi APs. In some embodiments, when the terminal 11 receives the device information broadcast by the WiFi AP 12, the terminal 11 can analyze the acquired device information to obtain the SSID, MAC address, and connection status about the WiFi AP 12.

At 605, the terminal 11 presents the connection status to a user. The process 605 is similar to the process 306 described above in connection with FIGS. 3A, 3E, 3F, and 4, and thus detailed description of 605 is omitted here.

In the example described above in connection with FIG. 6, the terminal 11 receives the connection status of the WiFi AP 12 broadcast by the WiFi AP 12, and may not need to request for the connection status.

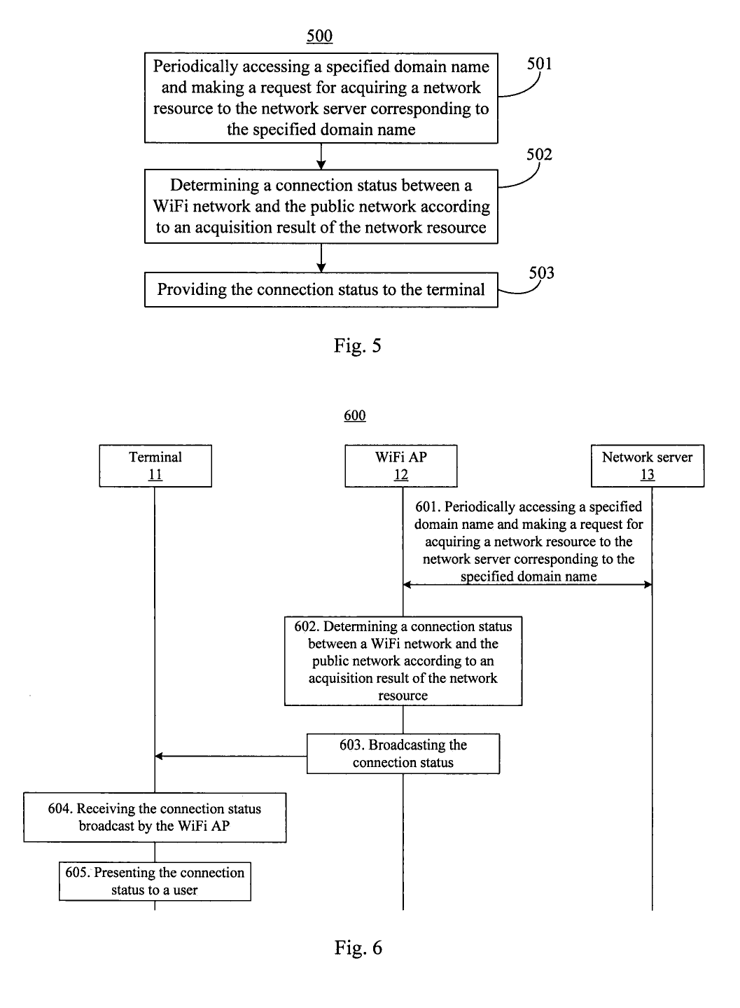

FIG. 7 is a flow chart of a connection status prompting method 700 according to another exemplary embodiment. The method 700 can be implemented, for example, in the implementation environment shown in FIG. 1. As shown in FIG. 7, processes 701 and 702 are similar to the processes 601 and 602 shown in FIG. 6 and described above. Therefore, detailed description of the processes 701 and 702 is omitted here.

At 703, the WiFi AP 12 sends the connection status to the currently connected terminal 11. The WiFi AP 12 may be connected with one or more terminals, and the WiFi AP 12 can send the connection status to at least one of the one or more terminals.

At 704, the terminal 11 presents the connection status received from the WiFi AP 12 to a user. The process 704 is similar to the process 306 described above in connection with FIGS. 3A, 3E, 3F, and 4, and thus detailed description of 704 is omitted here.

In some embodiments, the examples described above in connection with FIGS. 6 and 7 can be combined. For example, after determining the connection status, the WiFi AP 12 can broadcast the connection status and simultaneously send the connection status to a currently connected terminal.

Exemplary devices consistent with the present disclosure are described below, which can be configured to execute methods consistent with the present disclosure. Operations of these exemplary devices are similar to the exemplary methods described above, and thus detailed description of the operations is omitted here.

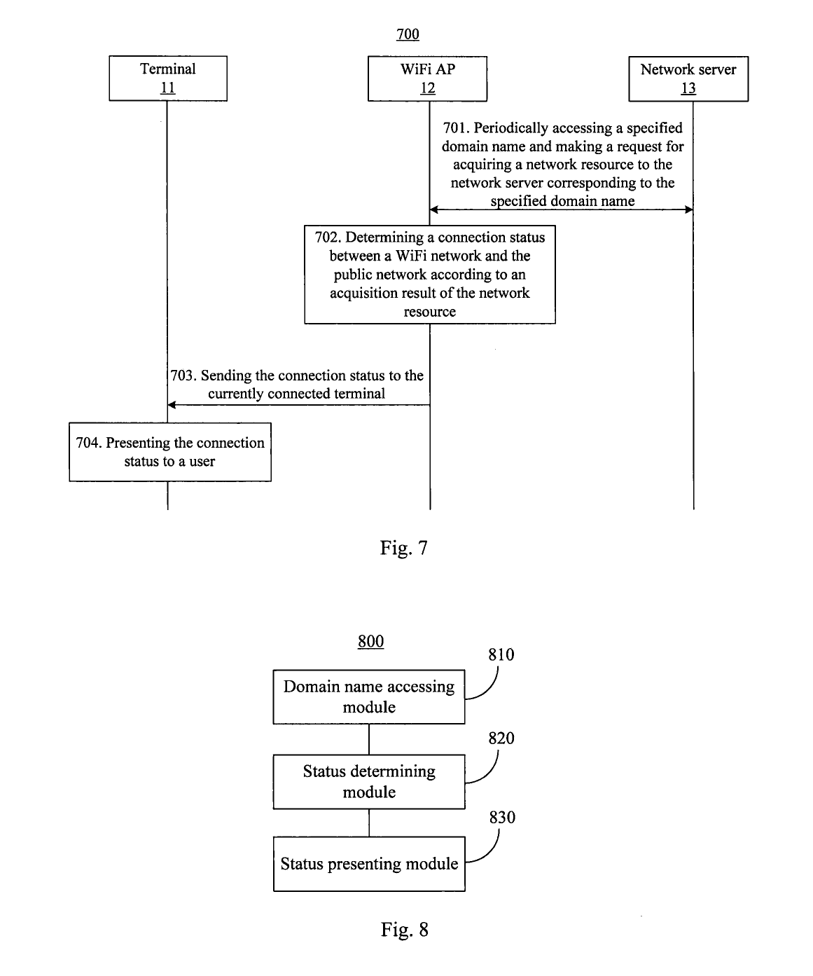

FIG. 8 is a block diagram illustrating a connection status prompting device 800 according to an exemplary embodiment. The device 800 can be implemented, for example, as a part or the whole of the terminal 11 in the implementation environment shown in FIG. 1. As shown in FIG. 8, the device 800 includes a domain name accessing module 810, a status determining module 820, and a status presenting module 830. The domain name accessing module 810 is configured to periodically access a specified domain name through an accessed WiFi network, and make a request for acquiring a network resource to a network server corresponding to the specified domain name. The status determining module 820 is configured to determine a connection status between the WiFi network and a public network according to an acquisition result of the network resource. The connection status includes a connected status and a disconnected status. The status presenting module 830 is configured to present the connection status to a user.

In some embodiments, the domain name accessing module 810 is configured to receive a WiFi network acquisition instruction, search for WiFi APs according to the WiFi network acquisition instruction to locate a target WiFi AP from discovered WiFi APs, access a WiFi network provided by the target WiFi AP, and send the request for acquiring the network resource to the network server corresponding to the specified domain name through the WiFi network.

In some embodiments, the status determining module 820 is configured to detect whether the network resource fed back by the network server corresponding to the specified domain name is received. If the network resource is received, the status determining module 820 determines that the connection status between the WiFi network and the public network is the connected status. If the network resource is not received, the status determining module 820 determines that the connection status between the WiFi network and the public network is the disconnected status.

In some embodiments, the status determining module 820 is configured to further acquire a data transmission rate at the time of receiving the network resource and include the data transmission rate in the connection status. In such case, the status presenting module 830 presents the data transmission rate to the user as the connection status.

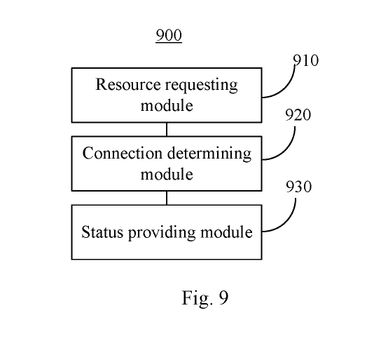

FIG. 9 is a block diagram illustrating a connection status prompting device 900 according to another exemplary embodiment. The device 900 can be implemented, for example, as a part or the whole of the WiFi AP 12 in the implementation environment shown in FIG. 1. As shown in FIG. 9, the device 900 includes a resource requesting module 910, a connection determining module 920, and a status providing module 930. The resource requesting module 910 is configured to periodically access a specified domain name and make a request for acquiring a network resource to a network server corresponding to the specified domain name. The connection determining module 920 is configured to determine a connection status between a WiFi network and a public network according to an acquisition result of the network resource. The connection status includes a connected status and a disconnected status. The status providing module 930 is configured to provide the connection status to a terminal for the terminal to present the connection status to a user.

In some embodiments, the status providing module 930 is configured to broadcast the connection status to enable the terminal connected to the WiFi network to acquire the connection status.

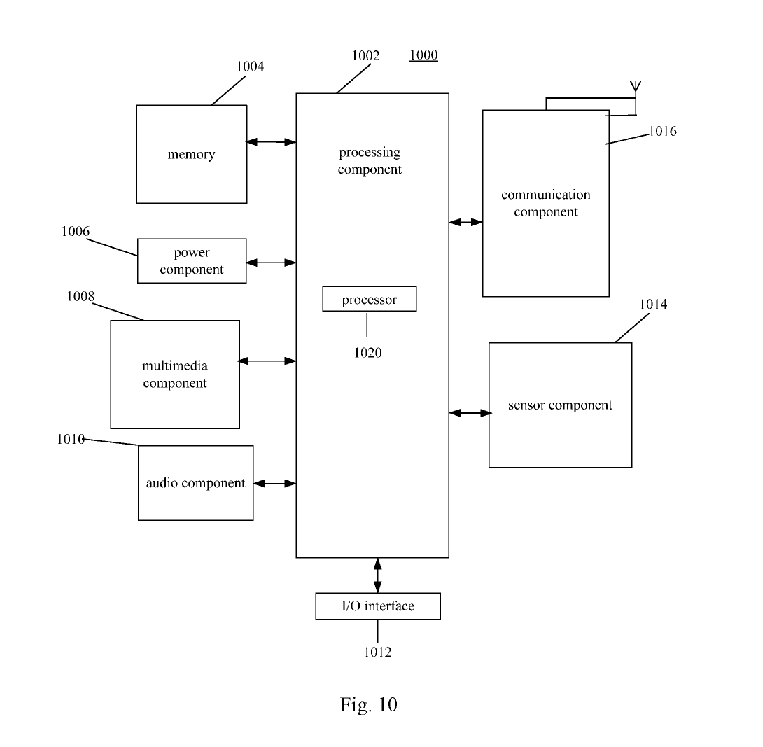

FIG. 10 is a block diagram illustrating a connection status prompting device 1000 according to another exemplary embodiment. For example, the device 1000 may be a mobile phone, a computer, a digital broadcast terminal, a messaging device, a gaming console, a tablet, a medical device, an exercise equipment, a personal digital assistant, or the like.

Referring to FIG. 10, the device 1000 includes one or more of the following components: a processing component 1002, a memory 1004, a power component 1006, a multimedia component 1008, an audio component 1010, an Input/Output (I/O) interface 1012, a sensor component 1014, and a communication component 1016.

The processing component 1002 typically controls overall operations of the device 1000, such as the operations associated with display, telephone calls, data communications, camera, and recording . The processing component 1002 may include one or more processors 1020 to execute instructions to perform all or part of the steps in the abovementioned methods. Moreover, the processing component 1002 may include one or more modules which facilitate interaction between the processing component 1002 and the other components. For instance, the processing component 1002 may include a multimedia module to facilitate interaction between the multimedia component 1008 and the processing component 1002.

The memory 1004 is configured to store various types of data to support the operation of the device 1000. Examples of such data include instructions for any applications or methods operated on the device 1000, contact data, phonebook data, messages, pictures, videos, etc. The memory 1004 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, or a magnetic or optical disk.

The power component 1006 provides power for various components of the device 1000. The power component 1006 may include a power management system, one or more power supplies, and other components associated with the generation, management and distribution of power for the device 1000.

The multimedia component 1008 includes a screen providing an output interface between the device 1000 and the user. In some embodiments, the screen may include a Liquid Crystal Display (LCD) and a touch panel. If the screen includes a touch panel, the screen may be implemented as a touch screen to receive an input signal from the user. The touch panel includes one or more touch sensors to sense touches, swipes and gestures on the touch panel. The touch sensors may not only sense a boundary of a touch or swipe action, but also sense a duration and pressure associated with the touch or swipe action. In some embodiments, the multimedia component 1008 includes a front camera and/or a rear camera. The front camera and/or the rear camera may receive external multimedia data when the device 1000 is in an operation mode, such as a photographing mode or a video mode. Each of the front camera and the rear camera may be a fixed optical lens system or have focusing and optical zooming capabilities.

The audio component 1010 is configured to output and/or input an audio signal. For example, the audio component 1010 includes a microphone, and the microphone is configured to receive an external audio signal when the device 1000 is in the operation mode, such as a call mode, a recording mode and a voice recognition mode. The received audio signal may be further stored in the memory 1004 or sent through the communication component 1016. In some embodiments, the audio component 1010 further includes a speaker configured to output audio signals.

The I/O interface 1012 provides an interface between the processing component 1002 and a peripheral interface module, and the peripheral interface module may be a keyboard, a click wheel, a button, or the like. The button may include, but is not limited to: a home button, a volume button, a starting button, or a locking button.

The sensor component 1014 includes one or more sensors configured to provide status assessment in various aspects for the device 1000. For instance, the sensor component 1014 may detect an on/off status of the device 1000 and relative positioning of components, such as a display and small keyboard of the device 1000, and the sensor component 1014 may further detect a change in a position of the device 1000 or a component of the device 1000, presence or absence of contact between the user and the device 1000, orientation or acceleration/deceleration of the device 1000 and a change in temperature of the device 1000. The sensor component 1014 may include a proximity sensor configured to detect presence of an object nearby without any physical contact. The sensor component 1014 may also include a light sensor, such as a Complementary Metal Oxide Semiconductor (CMOS) or Charge Coupled Device (CCD) image sensor, configured for use in an imaging application. In some embodiments, the sensor component 1014 may also include an acceleration sensor, a gyroscope sensor, a magnetic sensor, a pressure sensor or a temperature sensor.

The communication component 1016 is configured to facilitate wired or wireless communication between the device 1000 and another device. The device 1000 may access a communication-standard-based wireless network, such as a WiFi network, a 2nd-Generation (2G), 3rd-Generation (3G), or 4th-Generation (4G) network, or a combination thereof. In an exemplary embodiment, the communication component 1016 receives a broadcast signal or broadcast associated information from an external broadcast management system through a broadcast channel. In an exemplary embodiment, the communication component 1016 further includes a Near Field Communication (NFC) module to facilitate short-range communication. For example, the NFC module may be implemented on the basis of a Radio Frequency Identification (RFID) technology, an Infrared Data Association (IrDA) technology, an Ultra-WideBand (UWB) technology, a BlueTooth technology and other technologies.

In the exemplary embodiment, the device 1000 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned methods.

According to the present disclosure, there is also provided a non-transitory computer-readable storage medium including instructions, such as the memory 1004 including instructions and the instructions may be executed by the processor 1020 of the device 1000 to implement the above-described methods. For example, the non-transitory computer-readable storage medium may be a ROM, a Compact Disc Read-Only Memory (CD-ROM), a magnetic tape, a floppy disc, an optical data storage device, or the like. The instructions, when executed by the processor of the device 1000, cause the device 1000 to perform a connection status prompting method consistent with the present disclosure, such as one of the above-described exemplary methods.

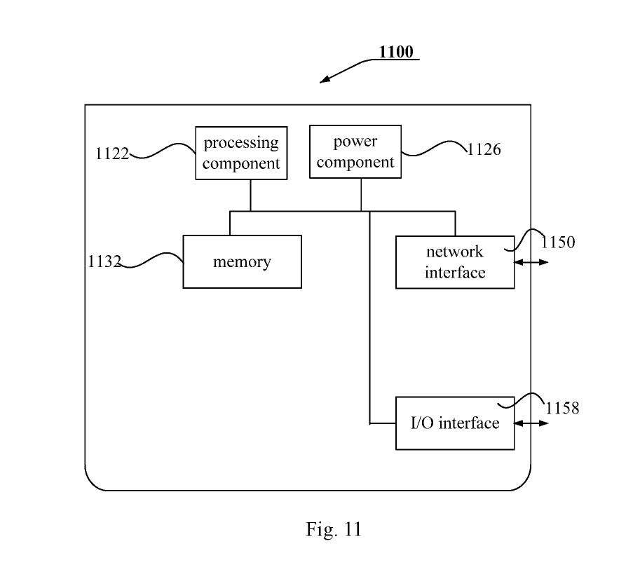

FIG. 11 is a block diagram of a connection status prompting device 1100 according to another exemplary embodiment. For example, the device 1100 may be provided as a WiFi AP. Referring to FIG. 11, the device 1100 includes a processing component 1122, which includes one or more processors, and a memory resource represented by a memory 1132 configured to store instructions executable by the processing component 1122, such as an application program. The application program stored in the memory 1132 may include one or more modules of which each corresponds to a set of instructions. In addition, the processing component 1122 is configured to execute the instructions to execute a connection status prompting method consistent with the present disclosure, such as one of the above-described exemplary methods.

The device 1100 further includes a power component 1126 configured to execute power management over the device 1100, a wired or wireless network interface 1150 configured to connect the device 1100 to a network and an I/O interface 1158. The device 1100 may be operated on the basis of an operating system stored in the memory 1132, such as Windows Server™, Mac OS X™, Unix™, Linux™, FreeBSD™ or the like.

According to the present disclosure, a terminal can determine whether a WiFi network is normally connected with the public network according to a connection status. As such, the prompting effect is improved. A user can easily learn about the connection status of a WiFi AP and thus the user experience can be improved.

Other implementation solutions of the present disclosure will be apparent to those skilled in the art from consideration of the specification and practice of the present disclosure. The application aims to cover any variations, uses or adaptive changes of the present disclosure. These variations, uses or adaptive changes follow general principles of the present disclosure and include such departures from the disclosure as common general knowledge or conventional technical means in the art. The specification and embodiments are only considered exemplary, and the scope and spirit of the disclosure will be indicated by the following claims.

It should be understood that the disclosure is not limited to the precise structures that have been described above or illustrated in the accompanying drawings, and various modifications and changes may be made without departing from the scope of the disclosure. The scope of the disclosure is limited by the appended claims.

What is claimed is:

1. A connection status prompting method, comprising:
periodically accessing a specified domain name through a Wireless-Fidelity (WiFi) network and making a request for acquiring a network resource to a network server corresponding to the specified domain name, the network server being in a public network;
determining a connection status between the WiFi network and the public network according to an acquisition result of the network resource, the connection status including one of a connected status or a disconnected status; and
presenting the connection status to a user.

2. The method according to claim 1, further comprising, before periodically accessing the specified domain name and making the request:
receiving a WiFi network acquisition instruction;
searching for WiFi Access Points (APs) according to the WiFi network acquisition instruction to locate a target WiFi AP from discovered WiFi APs, the target WiFi AP providing the WiFi network; and
accessing the WiFi network provided by the target WiFi AP.

3. The method according to claim 1, wherein determining the connection status includes:
detecting whether the network resource fed back by the network server is received;
determining, if the network resource is received, that the connection status is the connected status; and
determining, if the network resource is not received, that the connection status is the disconnected status.

4. The method according to claim 3, wherein:
the connection status further includes a data transmission rate, and
determining that the connection status is the connected status includes:
acquiring the data transmission rate when the network resource is received; and
determining the connection status according to the data transmission rate.

5. A connection status prompting device, comprising:
a processor; and
a memory storing instructions that, when executed by the processor, cause the processor to:
periodically access a specified domain name through a Wireless-Fidelity (WiFi) network and make a request for acquiring a network resource to a network server corresponding to the specified domain name, the network server being in a public network;
determine a connection status between the WiFi network and the public network according to an acquisition result of the network resource, the connection status including one of a connected status or a disconnected status; and
present the connection status to a user.

6. The device according to claim 5, wherein the instructions further cause the processer to, before periodically accessing the specified domain name and making the request:
receive a WiFi network acquisition instruction;
search for WiFi Access Points (APs) according to the WiFi network acquisition instruction to locate a target WiFi AP from discovered WiFi APs, the target WiFi AP providing the WiFi network; and
access the WiFi network provided by the target WiFi AP.

7. The device according to claim 5, wherein the instructions further cause the processer to:
detect whether the network resource fed back by the network server is received;
determine, if the network resource is received, that the connection status is the connected status; and
determine, if the network resource is not received, that the connection status is the disconnected status.

8. The device according to claim 7, wherein:
the connection status further includes a data transmission rate, and
the instructions further cause the processor to:
acquire the data transmission rate when the network resource is received; and
determine the connection status according to the data transmission rate.

9. A non-transitory computer-readable storage medium having stored therein instructions that, when executed by a processor of a mobile terminal, cause the mobile terminal to:
periodically access a specified domain name through a Wireless-Fidelity (WiFi) network and make a request for acquiring a network resource to a network server corresponding to the specified domain name, the network server being in a public network;
determine a connection status between the WiFi network and the public network according to an acquisition result of the network resource, the connection status including one of a connected status or a disconnected status; and
present the connection status to a user.
